(19) United States
(12) Patent Application Publication
(10) Pub. No.: US 2025/0139586 A1
(43) Pub. Date: May 1, 2025

(54) SYSTEM AND METHOD FOR ENHANCED EMAIL DELIVERABILITY ANALYSIS

(71) Applicant: Sidebored.io, Inc, Dover, DE (US)

(72) Inventors: Alexander Siegel, Dover, DE (US); Liam Siegel, Dover, DE (US); John Cross, Dover, DE (US)

(21) Appl. No.: 18/779,025

(22) Filed: Jul. 21, 2024

(51) Int. Cl. G06Q 10/107; H04L 51/212

(52) U.S. Cl. CPC G06Q 10/107; H04L 51/212

(57) ABSTRACT

A system for analyzing email deliverability and security includes a user computational device connected to a server gateway via a network. The server gateway directs emails to an accessible server and determines if an email recipient inbox has received the email and its categorization, such as SPAM. An analysis engine analyzes the category and content of each email to identify connections between them. The system also features a probe sender that sends test emails based on user instructions. Additionally, the system may directly access email inboxes, interface with multiple email servers, and include servers for collecting additional email data and cybersecurity information. The server gateway can connect to various email data sources and interfaces, including IMAP and JSON based APIs, and may utilize OAuth and OIDC protocols for programmatic email label and folder determination.

### FIELD OF THE INVENTION

The present invention is to a system and method for analyzing and enhancing email deliverability, and in particular, to such a system and method that utilizes probe emails and machine learning to dynamically assess and improve email classification across various email servers and inboxes.

### BACKGROUND OF THE INVENTION

Email communication has become a cornerstone of modern digital interaction, serving as a primary means for personal, commercial, and informational exchanges. The infrastructure supporting email communication includes a variety of computational devices, networks, and servers that work in concert to deliver messages from senders to recipients. Central to this process are email servers that manage the storage, forwarding, and retrieval of email messages. These servers employ various protocols, such as the Internet Message Access Protocol (IMAP) and Post Office Protocol (POP3), to facilitate the flow of emails across the internet.

To achieve the best email deliverability, senders need to ensure that their messages reach the intended recipients' inboxes effectively. Email servers utilize complex algorithms and filtering mechanisms to categorize incoming emails, which can result in emails being sorted into categories such as primary, social, promotions, or even being flagged as spam. The categorization process is influenced by numerous factors, including the content of the email, the sender's reputation, and the recipient's preferences and behaviors.

The classification of emails by these servers plays a pivotal role in the visibility and accessibility of messages to end-users. As such, the ability to analyze and predict email server behaviors regarding message categorization is of great interest to entities engaged in email marketing, information dissemination, and other forms of electronic communication. The development of systems and methods to assess and enhance email deliverability is an ongoing endeavor in the field of electronic messaging and communication.

### SUMMARY OF THE INVENTION

According to an embodiment of the present invention, a system for email deliverability and security analysis includes a user computational device connected through a computer network to a server gateway. The server gateway is configured to direct emails to an accessible email server which manages email communications within the system. The server gateway is further configured to determine whether an email recipient inbox has received the email and whether the email was categorized according to a specific category, such as SPAM.

Optionally, the server gateway may directly access the email recipient inbox to determine the categorization of the email. The system may also include an analysis engine configured to analyze the assigned category of each email message and the content of that message to determine the connection between the assigned category and the content.

According to another embodiment of the present invention, the user computational device includes a user interface for receiving instructions from a user regarding email messages to be sent. The server interface of the server gateway receives these instructions and executes them, causing a probe sender to send one or more probe email messages to test the categorization of the emails.

Optionally, the user computational device may comprise a user processor and a user memory, and the server gateway may comprise one or more server processors and a server memory with related functions. The user computational device and the server gateway may each include an electronic storage.

According to another embodiment of the present invention, the server gateway is in communication with a plurality of email servers, each associated with respective inboxes. The analysis engine receives information about the categorization of probe email messages from the inboxes, supported by the email servers.

Optionally, the system may include an additional email data server and a cybersecurity data server for collecting information such as SPAM or phishing reports, or other reports of problematic email categorization.

According to another embodiment of the present invention, the system includes various types of entangled inboxes as targets for the probe emails sent by the probe sender to assess email deliverability. These entangled inboxes may include a domain-specific entangled inbox, a user-provided entangled inbox, and a third-party email provider entangled inbox.

Optionally, the server gateway may connect to various email data sources and interfaces, including an IMAP Based Data Source and a JSON Based Mail API. The system may also include an analysis engine interface, a data preprocessing module, an artificial intelligence module, and an analysis engine database for processing and storing data.

According to another embodiment of the present invention, the system includes an email classification and analysis system designed to facilitate the detection and reporting of email presentation to the user and to provide feedback to the sender regarding the deliverability status of the email.

Optionally, the system may utilize protocols such as OAuth and OIDC to programmatically determine the labels and folders of emails, allowing the system to operate at scale and provide comprehensive deliverability insights. The system may also include a quality throughput control that uses feedback on deliverability to modify sending rates dynamically.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Unless otherwise defined, all technical and scientific terms used herein have the same meaning as commonly understood by one of ordinary skill in the art to which this invention belongs. The materials, methods, and examples provided herein are illustrative only and not intended to be limiting.

An algorithm as described herein may refer to any series of functions, steps, one or more methods or one or more processes, for example for performing data analysis.

Implementation of the apparatuses, devices, methods and systems of the present disclosure involve performing or completing certain selected tasks or steps manually, automatically, or a combination thereof. Specifically, several selected steps can be implemented by hardware or by software on an operating system, of a firmware, and/or a combination thereof. For example, as hardware, selected steps of at least some embodiments of the disclosure can be implemented as a chip or circuit (e.g., ASIC). As software, selected steps of at least some embodiments of the disclosure can be implemented as a number of software instructions being executed by a computer (e.g., a processor of the computer) using an operating system. In any case, selected steps of methods of at least some embodiments of the disclosure can be described as being performed by a processor, such as a computing platform for executing a plurality of instructions. The processor is configured to execute a predefined set of operations in response to receiving a corresponding instruction selected from a predefined native instruction set of codes.

Software (e.g., an application, computer instructions) which is configured to perform (or cause to be performed) certain functionality may also be referred to as a “module” for performing that functionality, and also may be referred to a “processor” for performing such functionality. Thus, a processor, according to some embodiments, may be a hardware component, or, according to some embodiments, a software component.

Further to this end, in some embodiments: a processor may also be referred to as a module; in some embodiments, a processor may comprise one or more modules; in some embodiments, a module may comprise computer instructions-which can be a set of instructions, an application, software-which are operable on a computational device (e.g., a processor) to cause the computational device to conduct and/or achieve one or more specific functionality.

Some embodiments are described with regard to a “computer,” a “computer network,” and/or a “computer operational on a computer network.” It is noted that any device featuring a processor (which may be referred to as “data processor”; “pre-processor” may also be referred to as “processor”) and the ability to execute one or more instructions may be described as a computer, a computational device, and a processor (e.g., see above), including but not limited to a personal computer (PC), a server, a cellular telephone, an IP telephone, a smart phone, a PDA (personal digital assistant), a thin client, a mobile communication device, a smart watch, head mounted display or other wearable that is able to communicate externally, a virtual or cloud based processor, a pager, and/or a similar device. Two or more of such devices in communication with each other may be a “computer network.”

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIG. 1A shows a non-limiting, exemplary block diagram of a system for message security and deliverability according to at least some embodiments of the present disclosure;

FIG. 1B shows a non-limiting, exemplary schematic representation of a system for message security and deliverability with multiple email servers according to at least some embodiments of the present disclosure;

FIG. 1C shows a non-limiting, exemplary schematic of a computer network system for email deliverability and security analysis according to at least some embodiments of the present disclosure;

FIG. 2A shows a non-limiting, exemplary block diagram of a system for email deliverability and security analysis with various entangled inboxes according to at least some embodiments of the present disclosure;

FIG. 2B shows a non-limiting, exemplary block diagram of a system architecture for an email probe system according to at least some embodiments of the present disclosure;

FIGS. 2C-2E show three screenshots of the same email in the same mailbox, but accessed through different modalities;

FIG. 3A shows a non-limiting, exemplary block diagram of an analysis engine with a rules-based logic module according to at least some embodiments of the present disclosure;

FIG. 3B shows a non-limiting, exemplary block diagram of an analysis engine with an artificial intelligence module according to at least some embodiments of the present disclosure;

FIG. 4A shows a non-limiting, exemplary flowchart of an AI-based system for analyzing email data using a BiLSTM network according to at least some embodiments of the present disclosure;

FIG. 4B shows a non-limiting, exemplary schematic of an AI-based system for analyzing email data with a CNN according to at least some embodiments of the present disclosure; FIG. 5 shows a non-limiting, exemplary block diagram of an email classification and analysis system according to at least some embodiments of the present disclosure; FIG. 6A shows a non-limiting, exemplary flowchart of an AI training method using backpropagation according to at least some embodiments of the present disclosure; FIG. 6B shows a non-limiting, exemplary flowchart of an AI training method with convolutional layer processing according to at least some embodiments of the present disclosure;

FIG. 7 shows a non-limiting, exemplary block diagram of an email communication system with multiple email sender devices according to at least some embodiments of the present disclosure;

FIG. 8 shows a non-limiting, exemplary flowchart of an email content creation process according to at least some embodiments of the present disclosure;

FIG. 9 shows a non-limiting, exemplary flowchart outlining a process for optimizing email delivery based on labels according to at least some embodiments of the present disclosure; and

FIG. 10 shows an exemplary, non-limiting screenshot of a screen for requesting the user to permit access to their email inbox through OAuth/OIDC.

### DETAILED DESCRIPTION OF AT LEAST SOME EMBODIMENTS

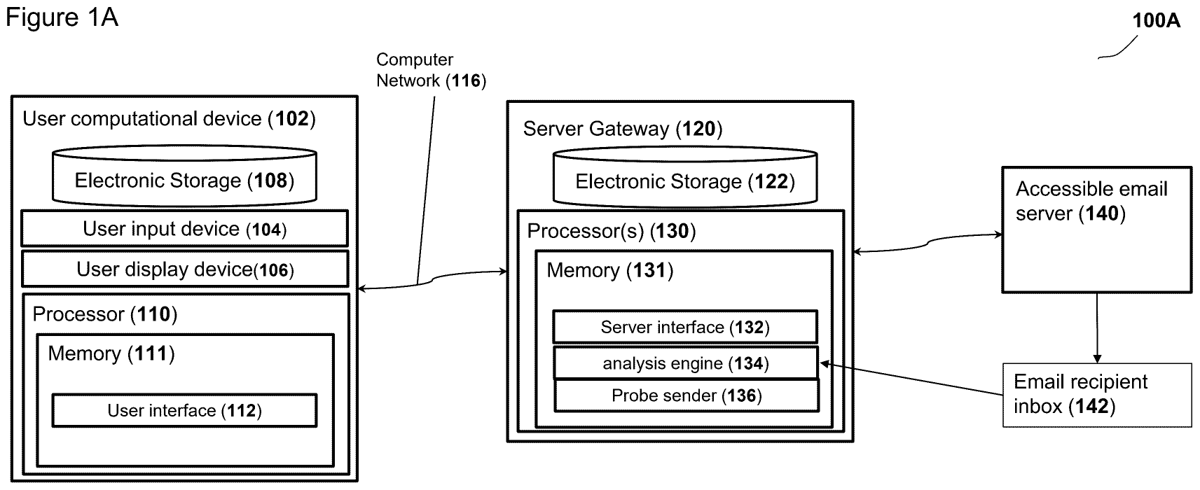

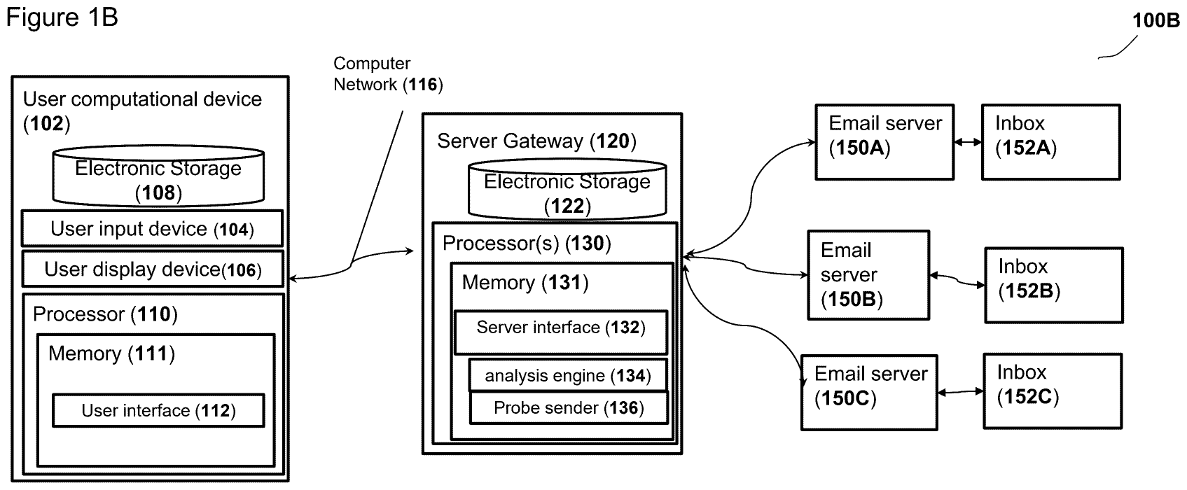

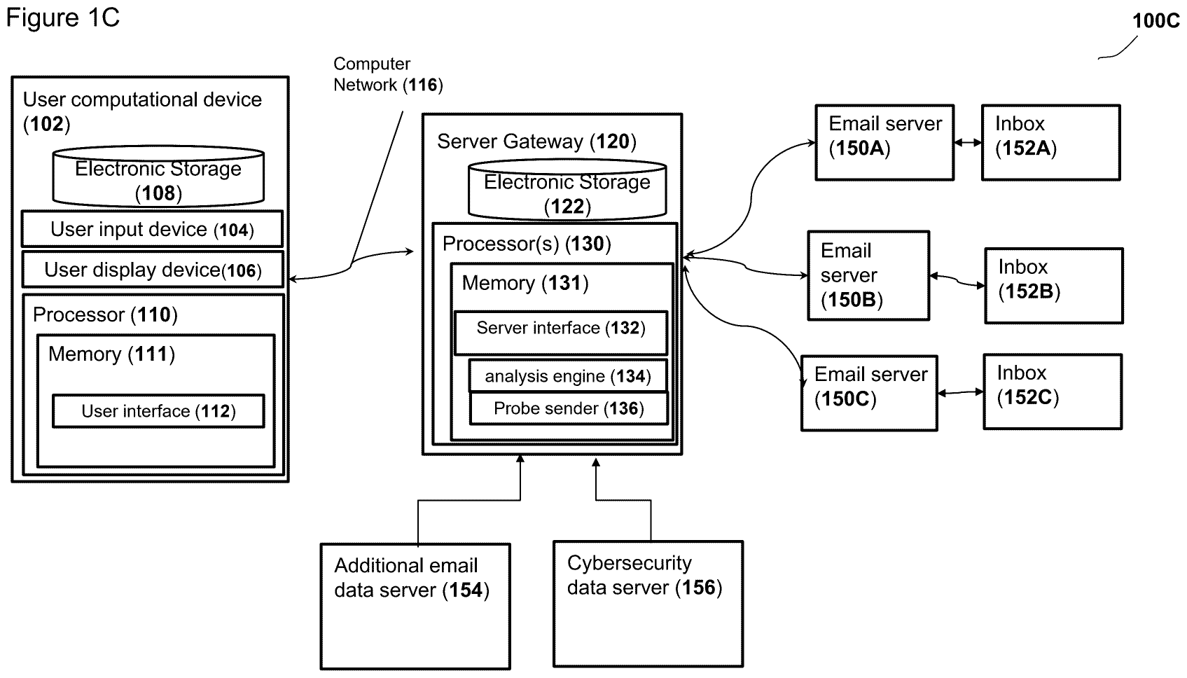

FIG. 1A presents a block diagram of a system 100A for message security and deliverability. System 100A includes a user computational device 102 that is connected through a computer network 116 to a server gateway 120. The system for sending probe emails may be controlled by user computational device 102, according to commands and interactions that are sent to server gateway 120. In turn, server gateway 120 is able to direct emails to be sent to an accessible email server 140, which manages email communications within the system. Next, such emails are sent to an email recipient inbox 142.

Server gateway 120 is preferably able to determine whether email recipient inbox 142 has received the email and if so, whether the email was categorized as SPAM or according to another category. Server gateway 120 is preferably able to detect the presentation of email to the user (in this non-limiting example, represented by email recipient inbox 142) and report such a presentation to user computational device 102. Server gateway 120 may do so by communicating with accessible email server 140, email recipient inbox 142, or a combination thereof.

The nuanced SPAM labeling occurs upon receipt of email messages to email recipient inbox 142. Typical algorithms at this level are customized to the user's inbox itself by the mail inbox provider. However, without having access to the mail inbox provider directly, it is difficult to determine how these algorithms operate.

Similarly, without access to email recipient inbox 142, server gateway 120 may only be able to detect the response of accessible email server 140, which may not provide sufficient information regarding the categorization of email messages as “SPAM” or some other category. Preferably, server gateway 120 is able to directly access email recipient inbox 142 to determine whether the message was categorized as “SPAM” or some other category.

Previously, the computing power was unavailable to do mass scanning of email accounts to determine the deliverability of email; however, recent advances in cloud computing makes massive introspection of email boxes feasible. Specifically, tens or even hundreds of thousands of email boxes may be inspected in an automated fashion to determine the actual deliverability of email. Deliverability as described herein refers not only to the traditional meaning of “hard bounce” and “soft bounce” results, but whether an email ends up flagged as SPAM, Important or other categorical assignments that may alter end-user visibility (that is, whether the end-user of the email inbox is able to easily see the message, or even see the message at all).

To support system 100A with such functions, user computational device 102 preferably comprises a user interface 112, for receiving one or more instructions from the user, for example in regard to one or more email messages to be sent. These instructions may then be sent to server gateway 120, for example through computer network 116. A server interface 132 of server gateway 120 then receives these instructions and executes them. For example and without limitation, server interface 132 may cause probe sender 136 to send one or more probe email messages, as tests or “probes” of whether these email messages are categorized as SPAM or as another category. These probe email messages may be sent through accessible email server 140, and then may be sent to email recipient inbox 142, as previously described.

Information regarding whether the one or more probe email messages were categorized as SPAM, or as another category, is then preferably made available to an analysis engine 134. Such information may be made available directly, through access to email recipient inbox 142; or indirectly, through querying of accessible email server 140. Analysis engine 134 preferably analyzes the assigned category of each probe email message, as well as the content of that message, to determine the connection between the assigned category and the content. Optionally, analysis engine 134 may note the assigned category and gather statistics over a plurality of probe email messages, with or without analyzing the content therein.

User computational device 102 also preferably comprises a user processor 110 and a user memory 111. User computational device 102 also comprises a processor 110 and a memory 111. Functions of processor 110 preferably relate to those performed by any suitable computational processor, which generally refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in memory 111. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Also optionally, memory 111 is configured for storing a defined native instruction set of codes. Processor 110 is configured to perform a defined set of basic operations in response to receiving a corresponding basic instruction selected from the defined native instruction set of codes stored in memory 111. For example and without limitation, memory 111 may store a first set of machine codes selected from the native instruction set for receiving instructions from the user through user interface 112, for example in regard to the type of email messages to be sent, and a second set of machine codes selected from the native instruction set for transmitting such information to server gateway 120 as instructions.

Similarly, server gateway 120 preferably comprises one or more server processors 130 and a server memory 131 with related or at least similar functions, including without limitation functions of server gateway 120 as described herein. For example and without limitation, memory 131 may store a first set of machine codes selected from the native instruction set for receiving instructions from user computational device 102, and a second set of machine codes selected from the native instruction set for executing functions of analysis engine 134 as previously described.

User computational device 102 preferably comprises an electronic storage 108 for storing data and other information. Similarly, server gateway 120 preferably comprises an electronic storage 122.

User computational device 102 preferably includes the user input device 104, and user display device 106. The user input device 104 may optionally be any type of suitable input device including but not limited to a keyboard, microphone, mouse, or other pointing device and the like. Preferably user input device 104 includes one or more of a microphone and a keyboard, mouse, or keyboard mouse combination.

For all of the Figures as shown herein, items with the same reference numbers as above have the same or at least similar functions, unless otherwise indicated.

FIG. 1B illustrates a schematic representation of system 100B for message security and deliverability. System 100B is similar as the previously described system, except that server gateway 120 is now in communication with a plurality of email servers 150, shown as three separate email servers for the purpose of illustration only and without any intention of being limiting: a first email server 150A, a second email server 150B and a third email server 150C.

Each email server 150 has its respective inbox as shown: a first email inbox 152A, a second email inbox 152B and a third email inbox 152C. Probe sender 136 now causes a plurality of email messages to be sent to email inboxes 152A-C. Analysis engine 134 now receives information about the categorization of such probe email messages from email inboxes 152A-C. Such communications are supported by email servers 150A-C, respectively.

By interacting with email inboxes 152, each of which may have different rules for handling SPAM and other categories, through a plurality of email servers 150 and according to a plurality of probe email messages, analysis engine 134 may now compare not only between email message content, but also between inboxes and email message servers.

FIG. 1C depicts a schematic of a computer network system 100C designed for email deliverability and security analysis. Two additional components have been added to the previously described system of FIG. 1B: an additional email data server 154 and a cybersecurity data server 156.

For each of FIGS. 1A-1C, various types of interactions with email inboxes, or “seed addresses”, may be performed. The system may run with any number of seed addresses, but preferably at scale, there are thousands, or even hundreds of thousands, of seed addresses. These addresses may optionally fall into one of two categories: System Provided and User Provided.

A System Provided seed address directs to a pre-configured mailbox within any of the above systems. For example, a non-limiting example of a System Provided seed address is “user-inbound-233-000@sampler.ourservice.com”. This email address may be supported by (accessed through) a Google Mailbox, an Office 365 Mailbox, a Proton mailbox, an Apple mailbox, a Yahoo mailbox, another platform mailbox, etc. Server gateway 120 is then provided with the credentials to verify the labels added to mail sent to this address—such as SPAM, IMPORTANT, etc.

A User Provided seed address may be used when server gateway 120 receives credentials from a human user for a mailbox (email address and inbox) that the user owns. For example, a user might own “me@my-company.com” and host this address at Google Mail. By performing an authentication exchange (called OAUTH), this user gives server gateway 120 access to their mailbox. Server gateway 120 then uses this User Provided seed address analogously as a System Provided account.

Overall, server gateway 120 preferably receives access to a target domain email address inbox. Such access may be provided by the user (owner of the specific email address inbox), as a system provided address, and/or through the target domain email server. The target domain email server may comprise a private server, and/or a supportive platform such as Google Mail, Outlook Mail, and so forth, as previously described.

For the first two types of provision (user or system provided), access to the actual inbox may be made in a number of ways, for example through such open standards as IMAP or POP3, and/or through vendor-specific APIs such as the GMail API (Google), the Outlook API (Microsoft) and so forth. These two types of provision do not require access to the email server itself, yet still provide the ability to read actual deliverability categorization and to receive the feedback of this deliverability information directly into server gateway 120. This direct access enables better quality control and higher feedback throughput, as well as the potential for automatic feedback and even changes to content, as described in greater detail below.

To support such analysis, optionally an additional email data server 154 collects further information, such as SPAM or phishing reports, or other reports of problematic email categorization. Such categorization may be problematic if incorrect (such that a desired email message from a valued sender is incorrectly designated as SPAM) but may also indicate a problem with the content of the email message itself. Determining which situation is correct may depend upon human selection (for user provided email addresses) or data analysis (for system provided email addresses). Additional email data server 154 may collect such selections and/or data analyses in the form of reports.

A cybersecurity data server 156 may collect information regarding emails that the user agrees are SPAM, for example for further analysis in regard to phishing schemes and the like.

For further security, optionally probe email messages are designated in such a manner as to cause server gateway 120, for example through analysis engine 134, to only read these email messages. The designation may comprise particular text in a subject line, a hash, or other indicator, so that other email messages, that lack the designation, are not read.

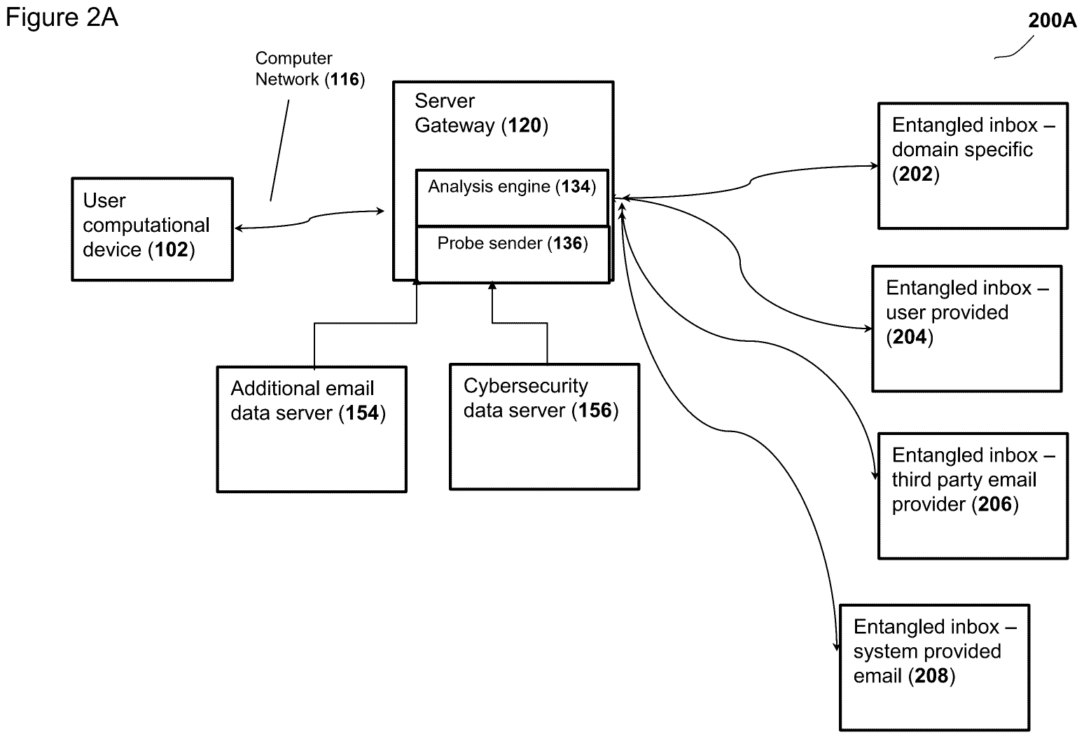

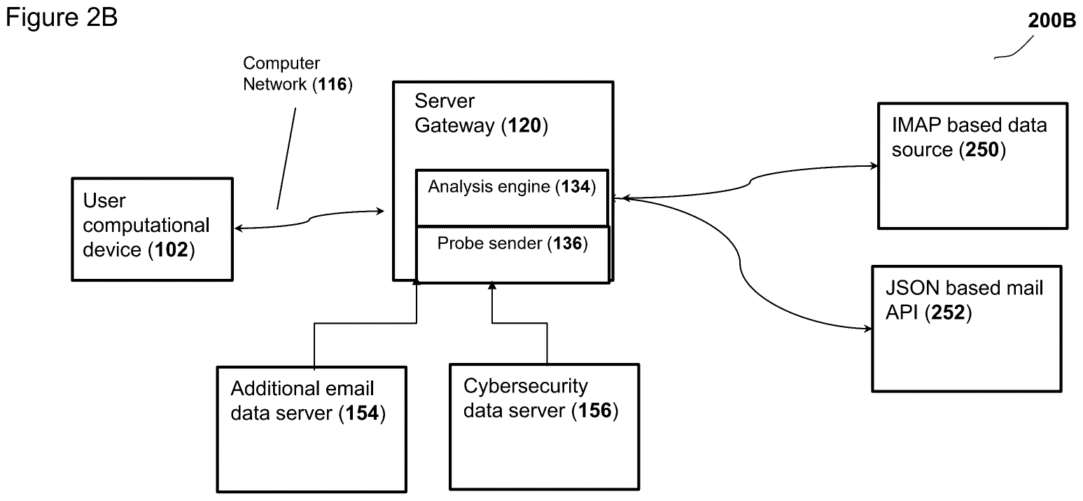

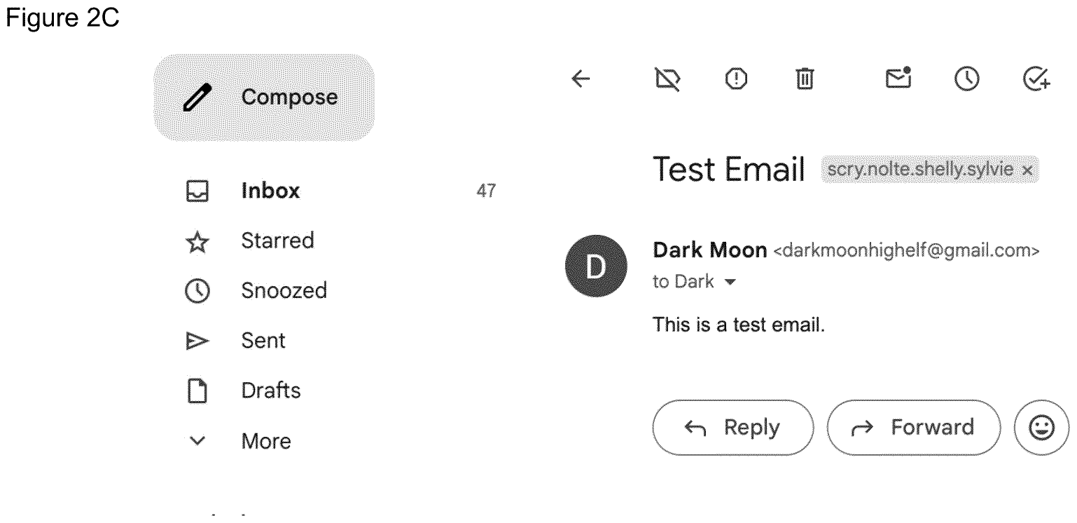

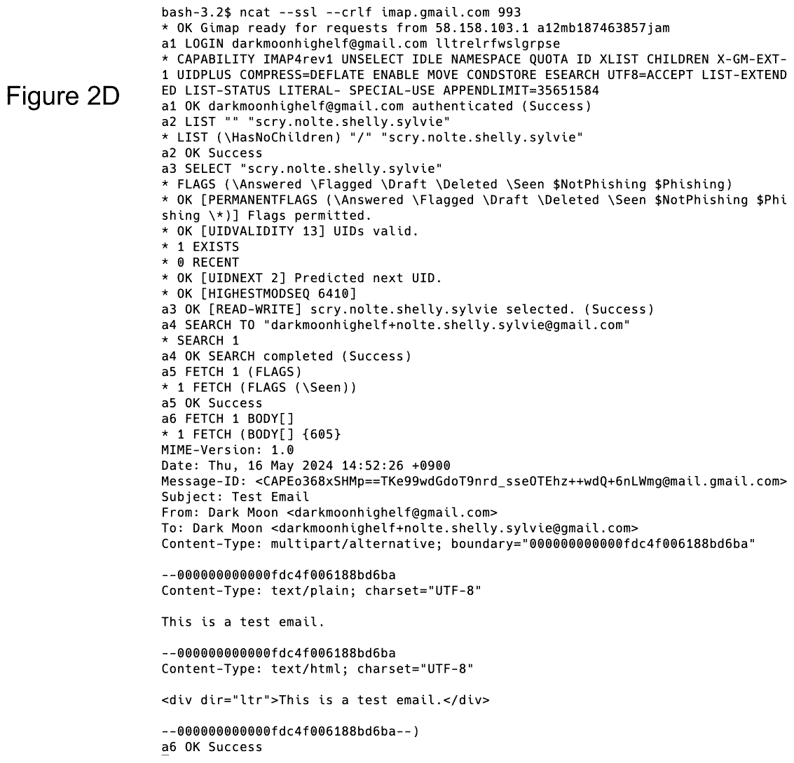

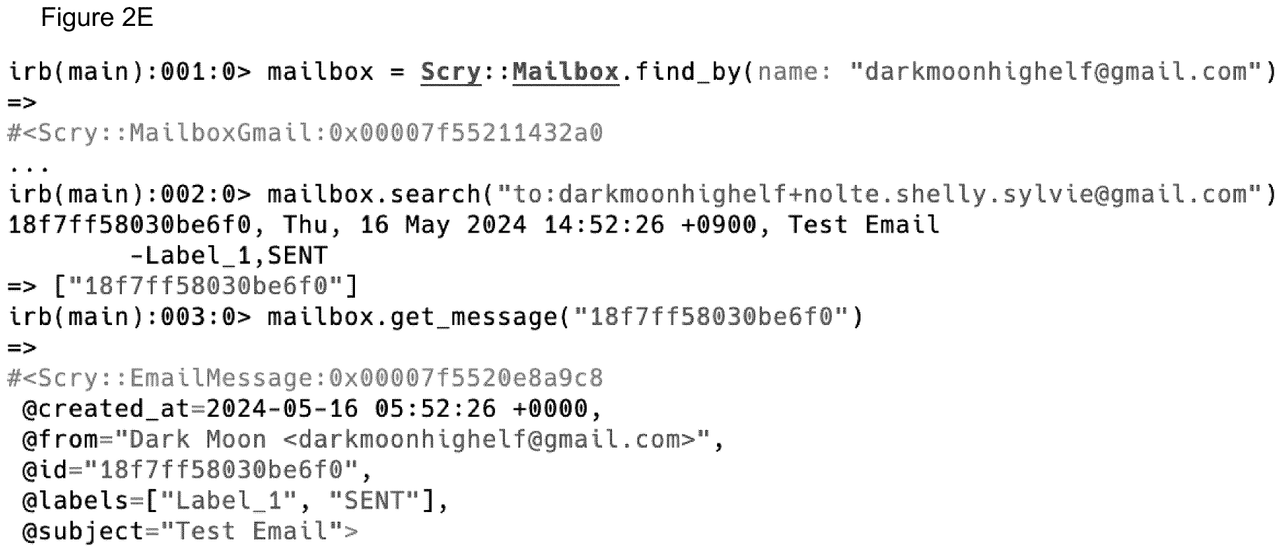

FIG. 2A presents a block diagram of a system for email deliverability and security analysis. Different types of “entangled” or accessible email inboxes are shown, as non-limiting examples. For example, a domain-specific entangled inbox 202 may comprise a system inbox that a particular email manager for a domain may have provided access to, so that server gateway 120 may access the email messages and their categorization as previously described. A user provided entangled inbox 204 corresponds to the previously described User Provided seed address. A third party email provider entangled inbox 206 corresponds to the previously described Google or Outlook email platforms. A system provided entangled inbox 208 corresponds to the previously described System Provided seed address.

These are non-limiting examples of suitable targets for the probe emails sent by the probe sender 136 to assess email deliverability, as described above, where the entangled boxes become the source of information about deliverability by using “probe emails.”

FIG. 2B illustrates a block diagram of a system architecture for an email probe system, as a system 200B. Server gateway 120 is able to connect to various exemplary email data sources and interfaces, including but not limited to an IMAP Based Data Source 250 and a JSON Based Mail API (Application Programming Interface) 252. These connections may be made through a user interface (UI) or an API meant for other machines to use. “Entangling” a mailbox results from gaining access to a user's mailbox, whether through such an API or UI. These interfaces provide various means of searching for specific mail and determining how it was classified. FIGS. 2C-2E show three screenshots of the same email in the same mailbox, but accessed through different modalities. FIG. 2C shows a screenshot of accessing the email through a UI (Gmail's Web Client). FIG. 2D shows a screenshot of such access by using a standardized API (IMAP). FIG. 2E shows a screenshot of such access through a proprietary API (Gmail's REST JSON API).

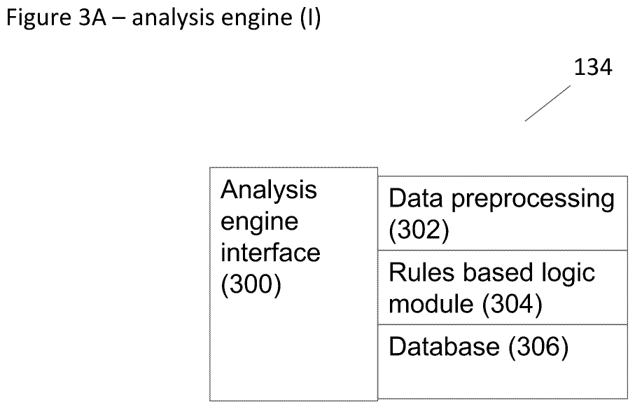

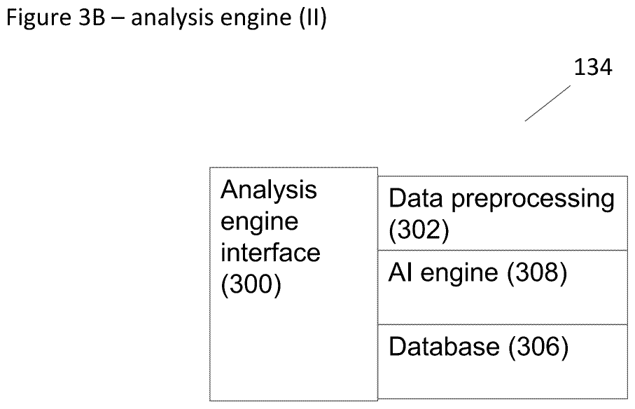

FIG. 3A presents a block diagram of a non-limiting, exemplary analysis engine 134. The analysis engine interface 300 serves as the entry point for data into the analysis engine 134. The data preprocessing module 302 is connected to the analysis engine interface 300 and is responsible for preparing data for analysis. The rules based logic module 304 is linked to the data preprocessing module 302 and applies predefined rules to the processed data. The analysis engine database 306 is connected to both the data preprocessing module 302 and the rules based logic module 304.

All emails are required to have a Message-ID which is decided by the email sender. Analysis engine 134 may be able to receive information obtained through access to the email provider API, for example by searching the email inbox by the message-id email header. Alternatively, a different strategy may be used. This strategy includes the addition of a unique “ID” (identifier) in the email sub-address. An email sub-address is a non-standardized but widely adopted convention of using a “+” symbol to help identify incoming mail. For example, an email user is able to sign up to a mailing list using me+list123@example.com, and is then able to label any incoming mail received to that address, for example to filter it into a separate folder. The unique ID may be generated randomly or from a hash of the email data.

By putting the ID into an email sub-address instead of the subject or body, the ID is not expected to alter or affect the classification made by the mail provider. Then IMAP Search functions may be used, as specified by RFC3501. A non-limiting, exemplary list may be found here: https://marshallsoft.com/ImapSearch.htm. Additionally or alternatively, proprietary search APIs may be used to query the entangled inbox for email destined to the sub-address, from email providers such as Google (https://support.google.com/mail/answer/7190) and Microsoft (https://learn.microsoft.com/en-us/graph/search-concept-messages). Both methods support inspection of emails sent to the entangled inbox without looking at or reading other, non-relevant email, which may for example comprise sensitive or personal email.

We can also preemptively create filters to label and hide email sent to the sub-address to prevent distracting and crowding of the user's inbox, as some email platforms and/or providers support the provision of labels or other methods to hide groups of email. Some mailbox providers also allow creating “push notifications” that will call back to our server whenever an email matches a filter. FIG. 3B depicts a block diagram of an analysis engine 134. The analysis engine 134 comprises an analysis engine interface 300, a data preprocessing module 302, an artificial intelligence module 308, and an analysis engine database 306. The analysis engine interface 300 serves as the entry point for data, which is then processed by the data preprocessing module 302 before being analyzed by AI module 308. The results of the analysis, along with the processed data, are stored in the analysis engine database 306. This arrangement indicates a systematic flow of data from input through processing to storage, which may be used to analyze the presentation of an email to the user and report it back to the sender. Various examples of suitable AI models for AI module 308 are described in greater detail below.

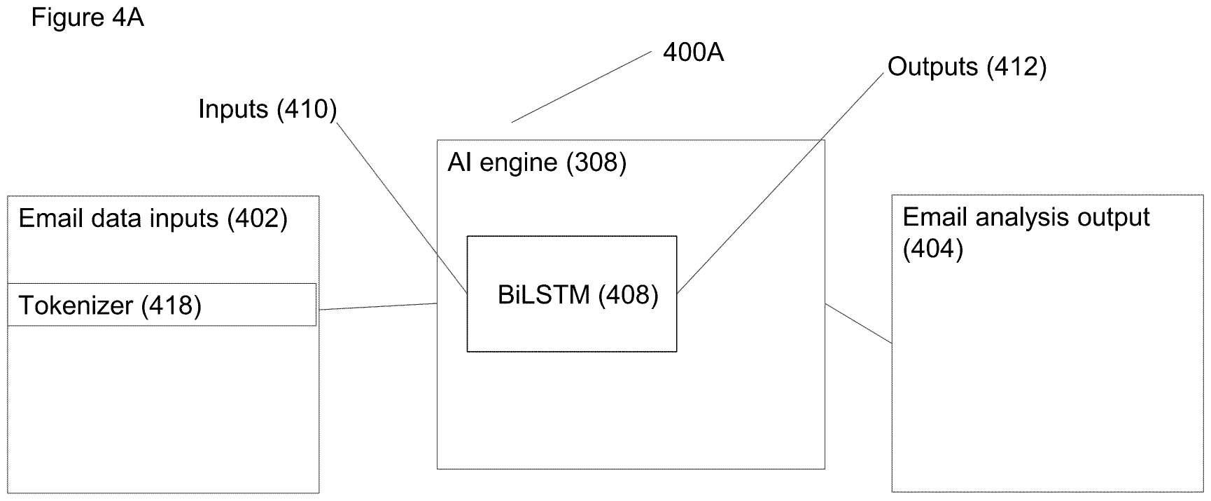

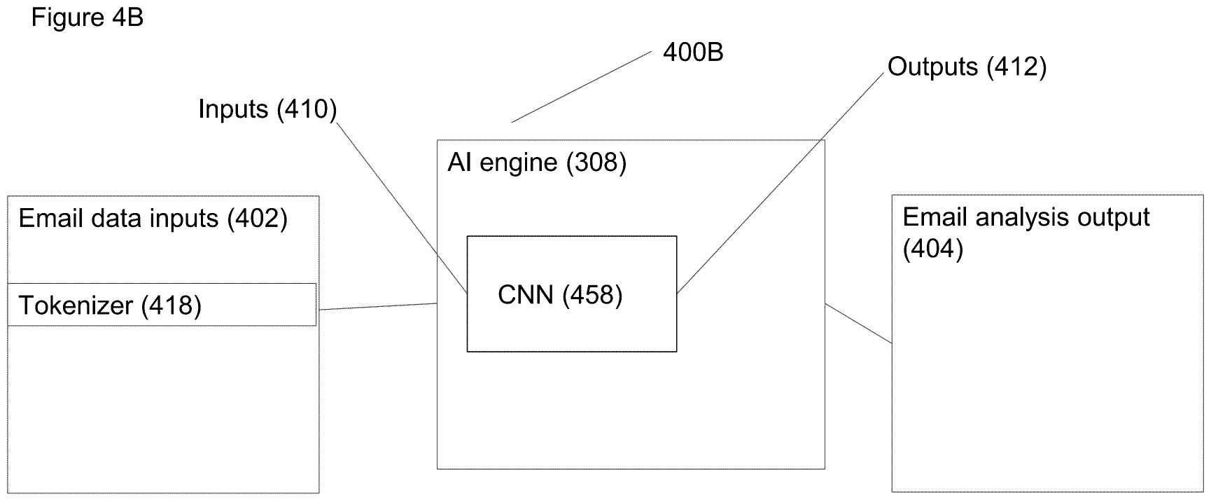

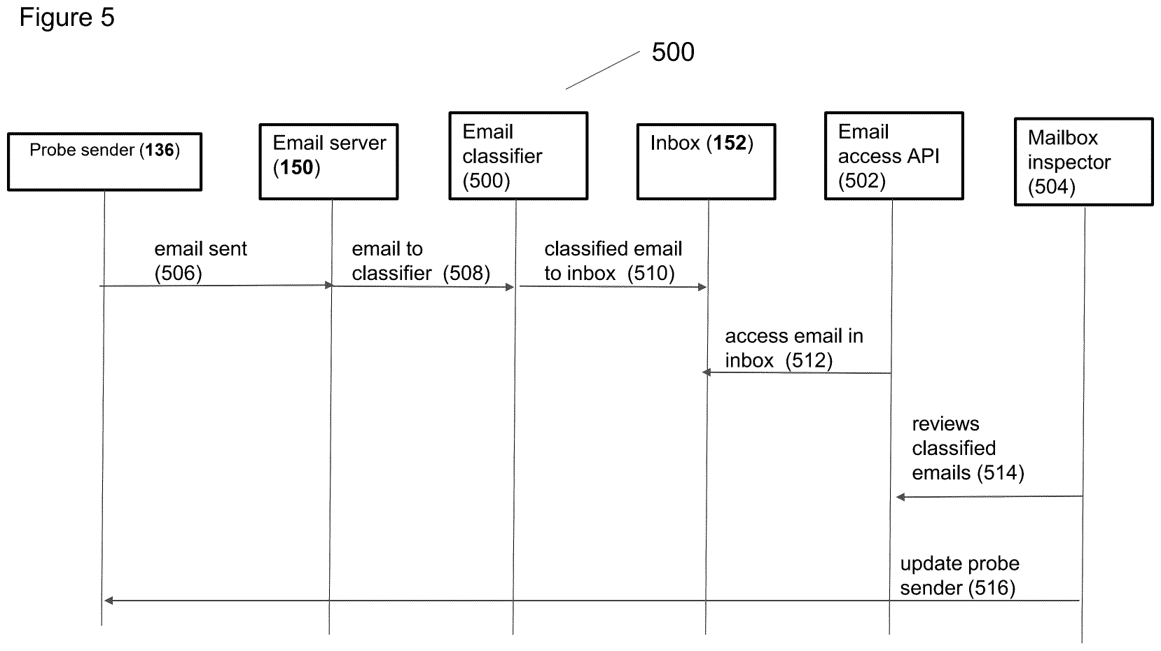

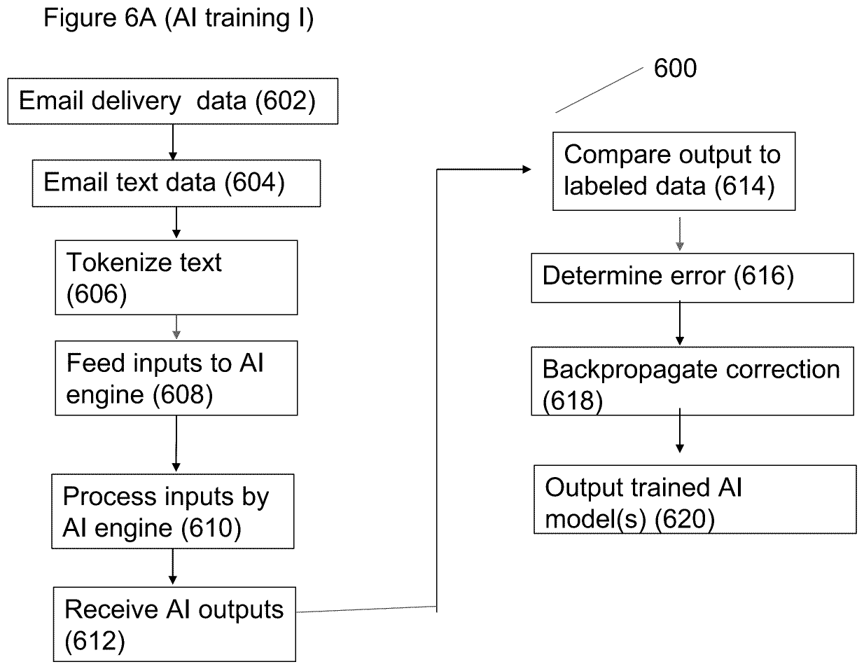

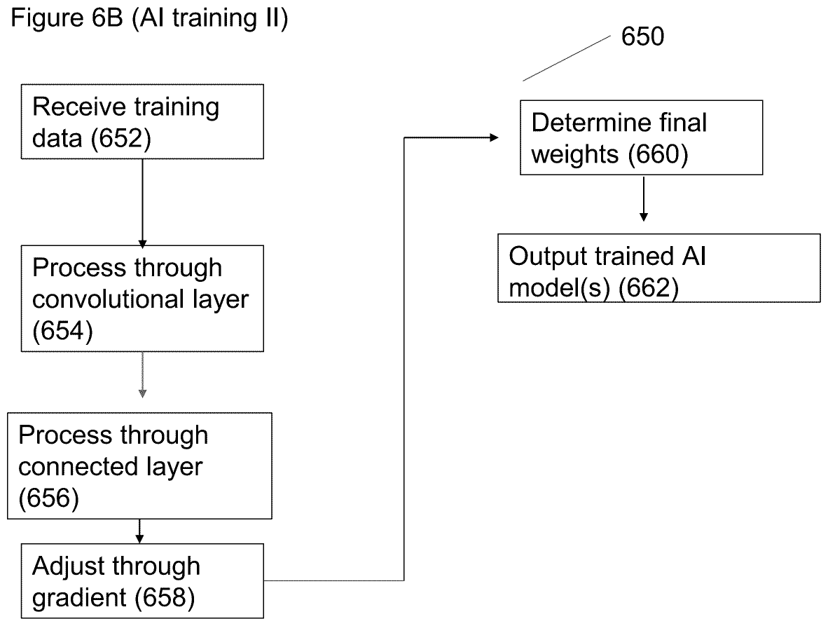

FIG. 4A depicts a flow diagram of an AI based system for analyzing email data, shown as first AI system 408. Email data input block 402 receives email data and passes it to data tokenizer block 418 within data inputs 410. Data tokenizer block 418 preferably performs text preprocessing, for example through tokenization, stemming, and/or removing stop words from the email content and headers. Optionally feature extraction is also performed to extract relevant features from the email data, such as the subject line, sender address, recipient address, body text, attachments, and any other relevant metadata.

The tokenized data is then sent to BILSTM (Bidirectional Long Short-Term Memory) 408 within AI engine 308. The processed data flows from the AI engine 308 to email analysis output block 404 in model outputs 412, where the final analysis of the email data is output. This flowchart illustrates the sequence of steps from receiving email data to producing an analysis output using a BiLSTM network for processing. BiLSTMs are a type of recurrent neural network (RNN) that can effectively process sequential data, such as text, speech, or time series data, to learn bidirectional long-term dependencies between such sequential data. These dependencies can be useful to enable the RNN to learn from the complete data series at each step.

In this non-limiting example, the BILSTM may be suitable for learning about consecutive sequences of email messaging over time, and/or according to different email platforms or providers. In the context of email analysis, a BILSTM could be used to build a model that classifies or predicts how different email providers, domains, third party email inbox or agent platforms, and/or specific user inboxes, handle probe emails.

The BILSTM can take the preprocessed email data as a sequence of features (e.g., word embeddings or character embeddings) and encode the sequential information in both forward and backward directions, to form an encoded sequence. The encoded sequence may then be fed into a fully connected layer or other classification/regression layers to predict how each email provider handles the test emails. The BILSTM model may be trained on a labeled dataset, where the labels indicate the behavior of different email providers (e.g., delivered to inbox, marked as spam, blocked, etc.).

Once the BILSTM model is trained, it can be used to analyze new test emails and interpret the results. The model's predictions can provide insights into patterns, differences, and potential issues in how various email providers, domains, third party email inbox or agent platforms, and/or specific user inboxes, handle probe emails.

Additionally, it is possible to use attention mechanisms with the BILSTM to identify which parts of the email (e.g., subject line, sender address, body content) are most influential in determining the email provider's behavior.

Other suitable RNN models that may be used include but are not limited to LSTMs (long short term memory models) and GRUs (Gated Recurrent Units).

FIG. 4B depicts a schematic of an AI based system for analyzing email data, shown as a second AI system 400B. The data inputs 410 leads to the initial email data input block 402, which is processed by the data tokenizer block 418 as described above. The tokenized data is then fed into Convolutional Neural Network (CNN) 458, as a non-limiting example of a suitable AI model. The model outputs 412 follows, culminating in the email analysis output block 404.

CNN 458 features multiple layers, including an embedding layer, that converts the preprocessed text data into numerical representations, such as word embeddings or character embeddings. This allows CNN 458 to process the text data as numerical inputs. Next, the convolutional layers in the CNN 458 extract local patterns and features from the email data. These layers apply filters (kernels) that slide over the input data and capture different n-gram patterns (e.g., sequences of words or characters).

Pooling layers are typically used after convolutional layers to downsample the feature maps and reduce the spatial dimensions of the data. This helps the model capture the most important features while reducing computational complexity.

Optionally, additional layers are present, depending on the complexity of the task. For example, additional convolutional and pooling layers may be added to extract higher-level features from the email data.

The output from the convolutional and pooling layers is then flattened and fed into one or more fully connected layers, which can learn combinations of features that are useful for the classification or prediction task.

The final output layer may then predict how each email provider handles the test emails. This prediction may involve a single node for binary classification (e.g., delivered or not delivered) or multiple nodes for multi-class classification (e.g., delivered to inbox, marked as spam, categorized as Important, etc.).

A CNN may also be useful for analyzing how different email providers handle test emails. CNNs are able to handle tasks involving sequential data, such as text or time series data. CNNs are able to effectively capture local patterns and features in the email data, which can be beneficial for this task. However, they may not capture long-range dependencies as well as RNNs or BiLSTMs.

Other non-limiting examples of suitable AI models include Attention-based Neural Networks (ANNs), as attention mechanisms may be combined with RNNs or CNNs to help the model focus on the most relevant parts of the email data (e.g., subject line, sender address, body content) when making predictions about how the above inboxes, platforms and providers handle the emails.

Sequence-to-Sequence (Seq2Seq) models, often used in neural machine translation, may also be used by treating the email data as the input sequence and the provider's handling (e.g., delivered to inbox, marked as spam or important, etc) as the output sequence.

FIG. 5 shows a non-limiting example of how the probe sender operates. The probe sender's main function is to deliver emails to entangled mailboxes and determine their classification.

The classification is made by the mailbox providers' analysis engine, determining its classification of emails by inspecting them after they have passed through the mailbox providers analysis engine and into the entangled mailbox. This type of classification is analogous to interactions with a GANN (Generative Adversarial Neural Network), and in fact could be trained on a GANN type model.

FIG. 5 shows a block diagram of an email classification and analysis system 500. The system 500 is designed to facilitate the detection and reporting of email presentation to the user and to provide feedback to the sender regarding the deliverability status of the email. The system 500 includes several components that work in conjunction to achieve this functionality. As previously described, probe sender 136 sends out probe emails to various email servers. The probe emails are crafted to include specific indicia that allow them to be identified and tracked by the system 500, for example as described herein.

Upon sending by the probe sender 136, the probe emails are received by the email server 150, also previously described. The email server 150 processes the incoming emails and directs them to the appropriate inboxes, labeled subfolders or categories, or other categories, or spam folders based on its internal filtering mechanisms.

Email classifier 500 then receives the emails from the email server 150 and classifies them according to predefined criteria. The classification may involve determining whether the emails are delivered to the inbox or marked as spam. The classified emails are then directed to the inbox 152 as previously described. The inbox 152 represents the destination of the emails where they are presented to the user.

Email access API 502 may then provide programmatic access to the emails within the inbox 152. It allows the system 500 to retrieve information about the emails, such as their classification status and the folder in which they are located. Other types of access may be provided as described herein.

A mailbox inspector 504 is a component that reviews the classified emails within the inbox 152. It utilizes the email access API 502 to inspect the emails and determine their deliverability status, such as whether they have been marked as spam or placed in specific categories like social, promotions, etc.

Turning now to the flow itself, at 506, the email is sent from the probe sender 136 to the email server 150. At 508, email server 150 directs the received email to the email classifier 500 for classification. Next at 510, the classified email is moved to the appropriate section, category or portion of inbox 152. At 512, the email is accessed within the inbox 152 using the email access API 502. At 514, the mailbox inspector 504 reviews the classification of the classified emails within the inbox 152. At 516, the probe sender 136 is updated, based on the classification results obtained by the mailbox inspector 504. The feedback provided to the probe sender 136 enables it to adjust future emails accordingly, enhancing the deliverability of subsequent messages.

The system 500 is particularly advantageous as it allows for real-time adjustments to the email sending strategy based on the deliverability feedback. This feedback loop is facilitated by the integration with protocols such as OAuth and OIDC, which provide the system 500 with the ability to programmatically access and analyze the email data. The system 500 can operate at scale, leveraging cloud computing resources to inspect large volumes of email inboxes and provide comprehensive deliverability insights. The system 500 exemplifies a novel approach to email deliverability monitoring by utilizing actual user inboxes as probes and offering a dynamic quality throughput control mechanism that has not been previously available.

FIG. 6A depicts a flowchart of an AI training method 600, which uses backpropagation. Backpropagation, also known as backward propagation of errors, is a widely used algorithm for training supervised neural networks, including CNNs, RNNs (such as LSTMs and BiLSTMs), and many other types of neural network architectures.

Turning now to method 600, initial email delivery data 602 is processed to extract email text data 604, which is then tokenized in text tokenization step 606. The tokenized data may be prepared as previously described.

The tokenized text is fed as input feed to AI engine 608, where AI engine processing 610 occurs. The AI output reception 612 is then compared to labeled data in output comparison to labeled data 614, leading to error determination 616.

Based on the errors identified, error backpropagation 618 is performed to adjust the AI model, culminating in the output of a trained AI model 620. The backpropagation algorithm works as follows:
1. Forward Pass: The input data is fed into the neural network, and the outputs are computed through the network's layers and activation functions.
2. Loss Calculation: The output of the network is compared to the expected output (ground truth labels), and a loss function (e.g., cross-entropy loss for classification, mean squared error for regression) is calculated to measure the difference between the predicted output and the actual output.
3. Backward Pass: The error (loss) is then propagated backward through the network, starting from the output layer and going towards the input layer. The gradients of the loss with respect to the weights and biases of each layer are computed using the chain rule of calculus.
4. Weight Update: The gradients calculated during the backward pass are used to update the weights and biases of the network layers using an optimization algorithm (e.g., Stochastic Gradient Descent, Adam, RMSProp) to minimize the loss function.

This process of forward pass, loss calculation, backward pass, and weight update is repeated for multiple iterations (epochs) over the training data until the model converges to a local minimum of the loss function.

Many types of neural networks, including but not limited to the previously described CNN and BiLSTM, rely on backpropagation to learn the optimal weights and biases that allow them to make accurate predictions or classifications on the given task. The backpropagation algorithm is a fundamental component of the training process for these models, enabling them to learn from data and improve their performance over time.

While backpropagation is the most commonly used algorithm for training neural networks, there are also other training algorithms and techniques, such as evolutionary algorithms, reinforcement learning, and contrastive divergence (for training restricted Boltzmann machines).

FIG. 6B depicts a flowchart of an AI training method 650, which may be used separately or which may be combined with the method of FIG. 6A, for example. The flowchart begins with the training data reception step 652, where training data is received. This data is then processed through a convolutional layer processing step 654, followed by a connected layer processing step 656. The data undergoes a gradient adjustment step 658 to refine the model based on the training data. The process concludes with a final weight determination step 660, which leads to the output of a trained AI model output step 662.

In a neural network with convolutional layers, the gradient adjustment step during training using backpropagation involves updating the weights and biases of the convolutional filters based on the computed gradients, for example as follows:
1. Forward Pass: During the forward pass, the input data (e.g., an image) is convolved with the learnable filters in the convolutional layer. This operation produces a feature map, which is then typically passed through an activation function (e.g., ReLU) and possibly a pooling layer.
2. Loss Computation: The output of the neural network is compared to the ground truth labels, and a loss function (e.g., cross-entropy for classification, mean squared error for regression) is computed.
3. Backward Pass: The backpropagation algorithm is used to compute the gradients of the loss function with respect to the weights and biases of the neural network layers, starting from the output layer and propagating backwards towards the input layer.
4. Gradient Computation for Convolutional Layers: In the convolutional layers, the gradients of the loss with respect to the learnable filters (weights) and biases are computed using the chain rule of calculus.
   a. Filter Gradients: The gradient of the loss with respect to each filter weight is calculated by convolving the incoming gradient from the previous layer with the input data (or feature maps from the previous layer).
   b. Bias Gradients: The gradient of the loss with respect to the bias of a convolutional filter is calculated by summing the incoming gradients from the previous layer over the spatial dimensions of the feature map.
5. Gradient Adjustment: Once the gradients for the convolutional filters and biases are computed, they are used to update the corresponding weights and biases using an optimization algorithm, such as Stochastic Gradient Descent (SGD) or Adam.
   a. Weight Update: The weight of each filter is updated by subtracting the product of the learning rate and the computed gradient from the current weight value.
   b. Bias Update: The bias of each filter is updated by subtracting the product of the learning rate and the computed bias gradient from the current bias.
6. Repeat: The forward pass, loss computation, backward pass, and gradient adjustment steps are repeated for multiple iterations (epochs) over the training data until the neural network converges to a local minimum of the loss function.

The gradient computation and adjustment process may involve additional techniques or considerations, such as padding, stride, and weight initialization, depending on the specific convolutional architecture and implementation details.

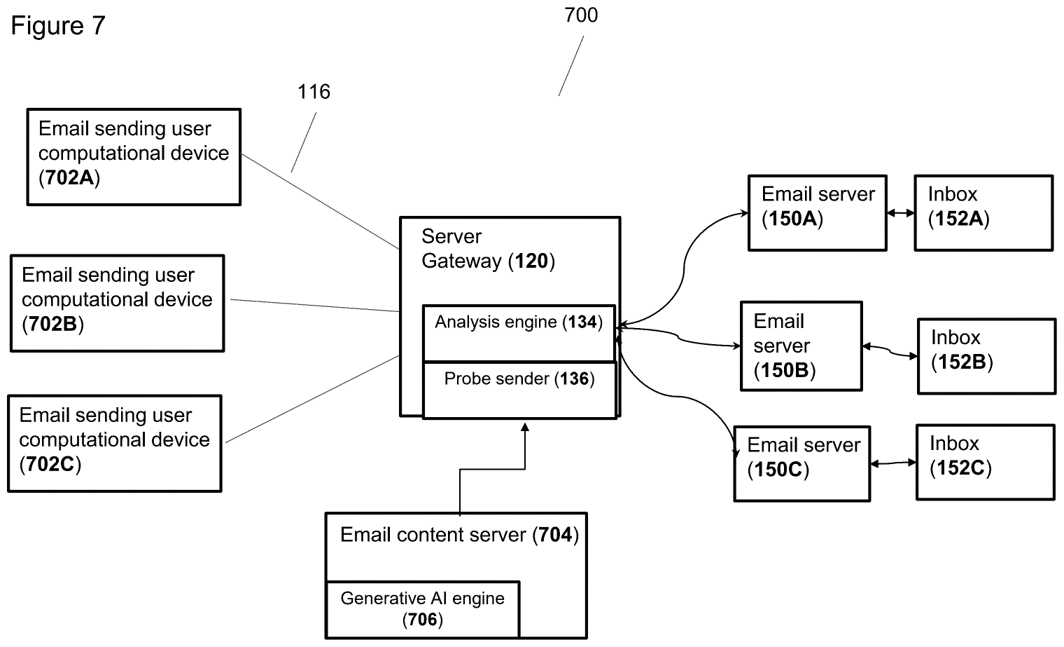

FIG. 7 depicts a block diagram of an email communication system, shown as a system 700. A plurality of email sender devices 702, of which three are shown for the sake of clarity and without any intention of being limiting, includes a first email sender device 702A, second email sender device 702B, and third email sender device 702C. Email sender devices 702 send emails to server gateway 120. Additionally, an email content management server 704 with a content generation AI engine 706 is depicted. Content generation AI engine 706 creates various types of email content, optionally varying the subject line, content of the body, provision of images, inclusion of a tracking pixel, and so forth. This email content is then sent as probe emails through email sender devices 702. Email content management server 704 analyzes the effect of these variables on the categorization of the probe email messages at the various email servers 150 and/or at the various email inboxes 152.

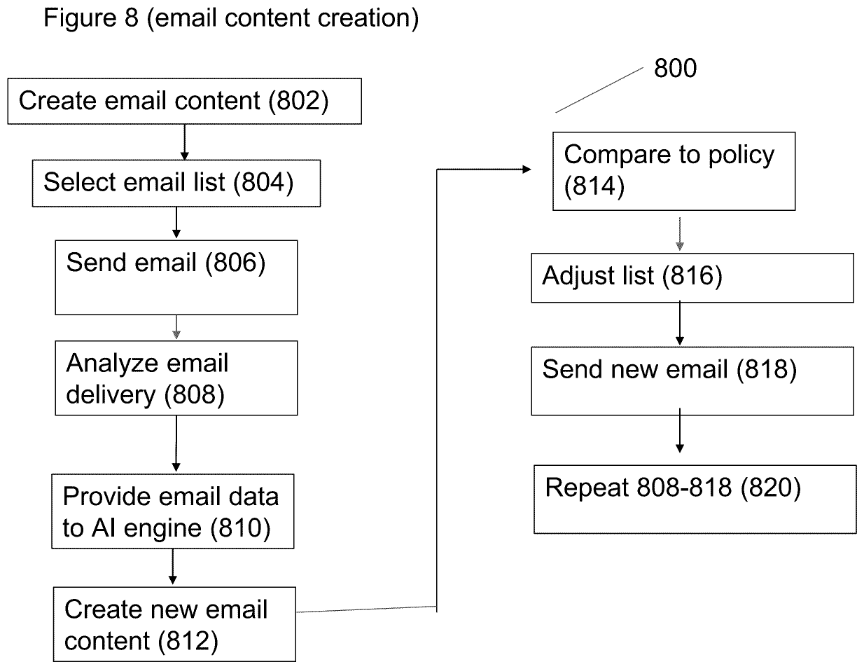

FIG. 8 depicts a flowchart of an email content creation process 800. The process begins with initial email content creation 802, followed by email list selection 804, and then email dispatch 806. After the emails are sent, a delivery analysis step 808 is conducted, which leads to AI engine data provision 810. The AI engine then generates new email content 812, which is compared against a policy in policy comparison step 814. Based on this comparison, an email list adjustment 816 is made, and a new email dispatch 818 occurs. The process includes a delivery analysis loop 820, to perform a repeated cycle of analysis and adjustment to optimize email deliverability at steps 808-818.

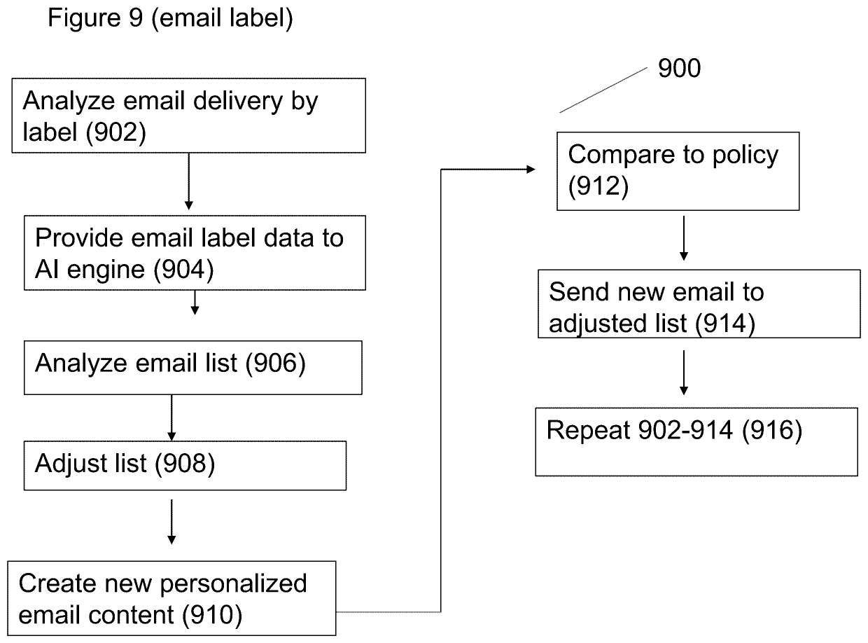

FIG. 9 depicts a flowchart 900 outlining a process for optimizing email delivery based on labels. The process begins with label based email analysis 902, where email delivery is analyzed by label. This analysis is followed by AI engine data provision 904, where email label data is provided to an AI engine. The AI engine then aids in email list analysis 906, which leads to email list adjustment 908. Once the list is adjusted, personalized email content creation 910 takes place, generating new content tailored to the adjusted list. The content is then subjected to a policy comparison step 912 to ensure it aligns with predetermined policies. If the content passes the policy comparison, it is dispatched to the adjusted list through adjusted list email dispatch 914. The process concludes with an optimization cycle repetition 916, such that the steps from analyzing email delivery to sending the new email are optionally repeated for continuous optimization.

Optionally, the differentiation between emails received by the inbox and those that went into spam (or other categories) is achieved through the integration with protocols such as OAuth/OIDC, allowing the system to programmatically determine the labels and folders of emails. OIDC is an acronym for OpenID Connect which is the authorization system based on OpenID. OAuth is much more commonly used to gain access to user accounts than OIDC.

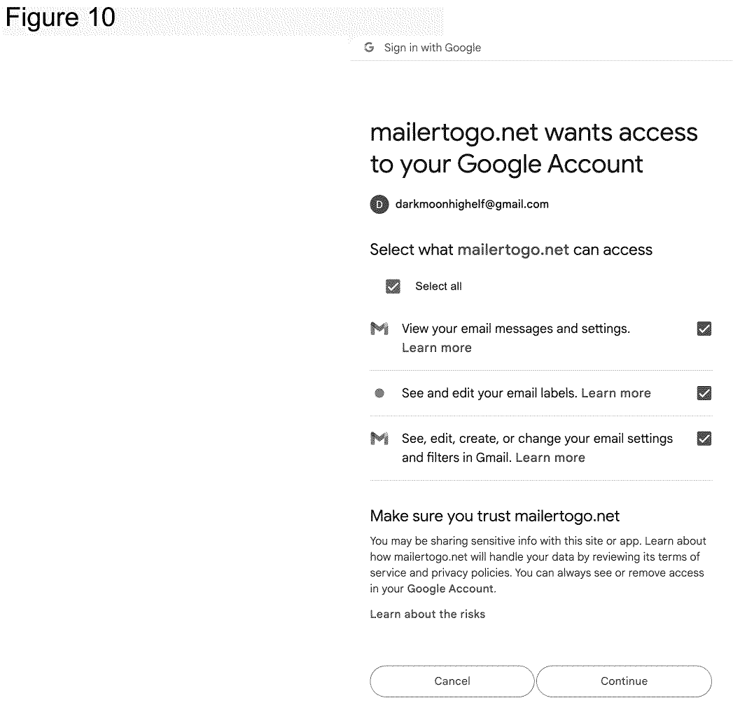

FIG. 10 shows an exemplary, non-limiting screenshot of a screen for requesting the user to permit access to their email inbox through OAuth/OIDC. Because email providers have also become OAuth/OIDC providers, it is common to delegate email access through using the email address as the login method. This enables a simple and integrated method to have users to this monitoring system simultaneously become data-point providers as actual probes. By integrating with OAuth, the email system can streamline user onboarding and data collection, making it even more effective.

When users log in to the monitoring system using their email address (which acts as their OAuth), they can grant the system limited access to their email data. This access can be specifically tailored to only retrieve the information necessary for deliverability monitoring, such as delivery confirmations, open rates, and spam filtering data. Users don't need to create separate accounts or install additional software. They simply use their existing email login credentials, making participation effortless. This integration can significantly increase the number of data points available for analysis, leading to more accurate and comprehensive deliverability insights. As more users join the system, the data pool grows exponentially, further enhancing the accuracy and value of the monitoring service through network effects.

This OAuth integration addresses a critical challenge in traditional deliverability monitoring: user recruitment and data collection. By leveraging existing email logins and OAuth protocols, the invention removes friction and incentivizes participation, leading to a richer and more accurate data set. Therefore, the system as described herein not only solves the problem of inaccurate deliverability data but also offers a novel and efficient way to collect data from real end-users through OAuth integration, in at least some embodiments.

Such an integration supports the execution of a master process that is either evented (notified when email is received) or has a polling loop that checks for new mail. On each loop or new email receipt, the system integration (for example through server gateway 120) may check to see if the email has the embedded probe indicator as previously described. If so, the status of the message (SPAM, Important, etc) is registered, and the original probe email deliverability is updated accordingly.

As previously described, such access may also be provided through IMAP, POP3 and/or a direct API integration.

The “quality throughput control” uses feedback on deliverability to modify sending rates dynamically, improving the system's efficiency and effectiveness. For example, typically mass email is sent with a bulk sending tool or provider. Some providers allow for testing batches of email prior to deploying an email to a population. However, a dynamic rate-adjusting algorithm that uses feedback on deliverability to modify sending is not yet available. Such an algorithm may be applied in a number of different ways. For example, probe emails may be sent to both population and probe accounts, while monitoring for a target deliverability rate. If the probe accounts show that deliverability is suffering, then the transmission of the rest of the batch of emails may be halted for remediation. As another non-limiting example, there are often limits put in place by bulk email senders that track the portion of mail marked as spam. In one embodiment, the probe accounts could be configured to automatically mark mail as NOT SPAM. By doing this, it would be possible to continue to send potentially millions of emails and effectively lower the percentage of mail marked as SPAM. Because there is some cost in sending mail, throttling is optionally applied. Optionally, the system may be constructed to automatically send some large number of emails guaranteed to be marked NON-SPAM for every few number of SPAM emails. This essentially means that a customer could state “deliver my emails at no more than a 2% SPAM rate” because their email delivery provider may cut their account if this rate is exceeded. A blunt algorithm would simply send more NON-SPAM marked email to stay within this SPAM rate. However, the presently described invention, in at least some embodiments, may remove probe emails out of the SPAM box, placing them instead into a hidden labeled box, for example. The user (person to whom the email address is connected) may be able to select specific domains for retaining email messages for example; and/or the system may apply AI to decide which messages to remove from SPAM and how to handle such messages, according to the instructions of the user (and/or observation of user behavior).

For example, IMAP has the concept of a Junk or SPAM folder as specified in RFC 6154. Proprietary APIs used to query entangled inboxes provide analogous assessors comparable to the IMAP standard that enable easy determination of whether an email was classified as spam. Regardless of whether the interface is IMAP or a Proprietary API, a person having ordinary skill in the art could construct a machine, “a program”, that performs the inspection of the entangled inbox and determines the email classification made by the inbox email provider.

Furthermore, an email can be tested before it is delivered to many, many inboxes by first sending it to a group of entangled inboxes and inspecting the classification made by the inbox email provider. If a large percentage of the entangled inboxes' mail providers classified the email as junk, spam, or unwanted, the email is preferably not delivered, thereby preventing the inadvertent transmission of large amounts of spam.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for email deliverability and security analysis, comprising:
a user computational device;
a computer network;
a server gateway connected to the user computational device through the computer network, the server gateway configured to direct emails to an accessible email server and to determine whether an email recipient inbox has received the email and the categorization of the email;
an analysis engine configured to analyze the assigned category of each email message and the content of that message to determine the connection between the assigned category and the content; and
a probe sender configured to send one or more probe email messages based on instructions received from the user computational device.

2. The system of claim 1, wherein the server gateway is further configured to directly access the email recipient inbox to determine the categorization of the email.

3. The system of claim 1, wherein the user computational device comprises a user interface for receiving instructions from a user regarding email messages to be sent.

4. The system of claim 1, wherein the server gateway comprises one or more server processors and a server memory.

5. The system of claim 1, wherein the server gateway is in communication with a plurality of email servers, each associated with respective inboxes.

6. The system of claim 1, further comprising an additional email data server configured to collect information related to email categorization.

7. The system of claim 1, further comprising a cybersecurity data server configured to collect information regarding emails identified as SPAM.

8. The system of claim 1, wherein the server gateway is configured to connect to an IMAP Based Data Source and a JSON Based Mail API.

9. The system of claim 1, wherein the analysis engine comprises an artificial intelligence module configured to process data received from the server gateway.

10. The system of claim 1, further comprising an email classification and analysis system configured to facilitate the detection and reporting of email presentation to the user and to provide feedback to the sender regarding the deliverability status of the email.

11. The system of claim 1, wherein the server gateway utilizes protocols including OAuth and OIDC to programmatically determine the labels and folders of emails.

12. The system of claim 1, wherein the server gateway includes a quality throughput control that uses feedback on deliverability to modify sending rates dynamically.
